(19) United States
(12) Patent Application Publication
(10) Pub. No.: US 2014/0170257 A1
(43) Pub. Date: Jun. 19, 2014

(54) MOLD

(71) Applicant: Hon Hai Precision Industry Co., Ltd., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/103,854

(22) Filed: Dec. 12, 2013

(30) Foreign Application Priority Data
Dec. 17, 2012 (TW) 101147747

(51) Int. Cl. B29C 33/76; B29C 33/02

(52) U.S. Cl. CPC B29C 33/76; B29C 33/02
USPC 425/468

(57) ABSTRACT

A mold includes a bottom portion defining a receiving chamber, a top plate located on a top of the bottom portion, and a mold core received in the receiving chamber. The mold core has a core plate and a removable plate that are fixed to the bottom portion. The removable plate is located under the core plate and supports the core plate. The core plate, the top plate, and sidewalls of the receiving chamber cooperatively define a mold cavity.

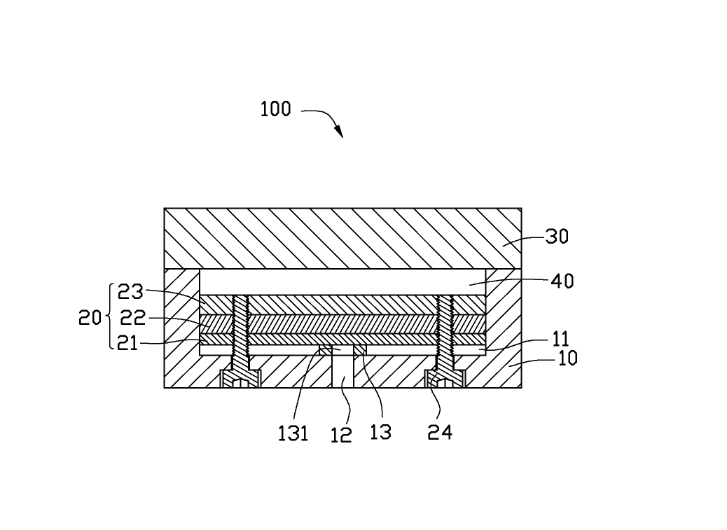

### BACKGROUND

1. Technical Field

The present disclosure relates to a mold.

2. Description of Related Art

Existing conventional mold for molding a light guide includes a core that has a top surface. The top surface cooperates with several sidewalls and a top plate to form a mold cavity. The top surface may be scratched after having been used many times. To fix this, the original core may be replaced with a new one. Although this existing mold can satisfy basic requirements, a new mold is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

The drawing is a schematic cross-sectional view of a mold according to one example.

### DETAILED DESCRIPTION

Embodiments of the present disclosure will be described with reference to the accompanying drawings.

Referring to the drawing, a mold 100 includes a bottom portion 10, a mold core 20, and a top plate 30. The bottom portion 10 defines a receiving chamber 11 and a through hole 12 communicating with the receiving chamber 11. The through hole 12 is connected to a coolant source (now shown). The through hole 12 is used to hold coolant that cools the mold core 20. A water-proof washer 13 is arranged on the bottom of the receiving chamber 11, and abuts against the bottom of the mold core 20. The water-proof washer 13 is used to prevent the coolant of the coolant source from entering the receiving chamber 11. The water-proof washer 13 defines a through hole 131 that is aligned with the through hole 12.

The mold core 20 is received in the chamber 11 of the bottom portion 10, and includes, from bottom to top, a bottom plate 21, a middle plate 22, and a top, core plate 23. The middle plate 22 is arranged under and supports the core plate 23. The bottom plate 21 is arranged under and supports the middle plate 22. Two fasteners 24 (e.g., screws) pass through the bottom of chamber 11, the bottom plate 21, the middle plate 22, and the top plate 23, and connects the mold core 20 to the bottom portion 10. The bottom plate 21 abuts against the water-proof washer 13.

The top plate 30 is located on the top of the bottom portion 10. The top plate 30, the core plate 23, and the sidewalls 14 of the bottom portion 10 cooperatively define a mold cavity 40 for receiving molten plastic. When the top surface of the core plate 23 is scratched, the core plate 23 can be removed from the bottom portion 10. The core plate 23 is then machined to remove the scratched top surface and to form a new top surface. After this, the thickness of the core plate 23 decreases. For maintaining the height of the mold cavity 40, a new middle plate is needed and has a greater thickness for compensating for the decreasing of the thickness of the core plate 23.

While various embodiments have been described and illustrated, the disclosure is not to be construed as being limited thereto. Various modifications can be made to the embodiments by those skilled in the art without departing from the true spirit and scope of the present disclosure.

What is claimed is:

1. A mold comprising:
a bottom portion defining a receiving chamber;
a top plate located on a top of the bottom portion; and
a mold core received in the receiving chamber, the mold core comprising a core plate and a removable plate that are fixed to the bottom portion, the removable plate being arranged under the core plate and supporting the core plate, the core plate, the top plate, and sidewalls of the receiving chamber cooperatively defining a mold cavity.

2. The mold according to claim 1, wherein the core plate and a removable plate are fixed to the bottom portion by screws.

3. The mold according to claim 1, wherein the mold core further comprises a bottom plate arranged under and supporting the removable plate.

4. The mold according to claim 4, wherein a bottom of the receiving chamber defines a through hole for holding coolant for cooling the mold core.

5. The mold according to claim 1, further comprising a water-proof washer abutting against the bottom plate and located on the bottom of the receiving chamber, wherein the water-proof washer defines a through opening aligned with the through hole of the bottom of the receiving chamber.
